(19) United States
(12) Patent Application Publication
(10) Pub. No.: US 2012/0225185 A1
(43) Pub. Date: Sep. 6, 2012

(54) METHOD FOR TREATING THE SURFACE OF A DEVICE FOR DISPENSING A FLUID PRODUCT

(75) Inventor: Pascal Bruna, Sotteville Les Rouen (FR)

(73) Assignee: VALOIS SAS, Le Neubourg (FR)

(21) Appl. No.: 13/508,202

(22) PCT Filed: Dec. 22, 2010
(86) PCT No.: PCT/FR10/52892

§ 371 Date: May 4, 2012

(30) Foreign Application Priority Data
Dec. 23, 2009 (FR) 0959493

(51) Int. Cl. B05D 5/00

(52) U.S. Cl. 427/2.3

(57) ABSTRACT

A treatment method for treating the surface of a fluid dispenser device, said method comprising the step of using chemical grafting to form a thin film on at least one support surface of at least one portion of said device that is in contact with said fluid, said thin film having bactericidal and/or bacteriostatic properties.

The present invention relates to a surface treatment method for fluid dispenser devices.

Fluid dispenser devices are well known. They generally comprise: a reservoir; a dispenser member, such as a pump or a valve; and a dispenser head that is provided with a dispenser orifice. In particular in the pharmaceutical field, any risk of contamination of the fluid to be dispensed may be critical, in particular when the fluid does not contain preservatives. Thus, dispenser devices for dispensing nasally or orally may be subjected to bacterial contamination. In particular, such contamination may take place inside the reservoir in which the fluid is stored, in particular by bacteria penetrating through the dispenser orifice, or it may take place outside the reservoir on contact with the patient, in particular around the dispenser orifice. In order to limit those risks, it has been proposed to filter the vent air or to use pumps without intake of air. Upstream from the dispenser orifice, it is also possible to provide a shutter that prevents the bacterial contamination from proliferating towards the reservoir between two uses of the device. However, those solutions are insufficient for the outside surfaces, e.g. the walls in contact with the inside of the nostrils during nasal dispensing. They are also insufficient for the inside surfaces, in particular during the dispensing stage when a shutter, if any, is in its open position. In order to limit still further any risk of bacterial contamination inside and outside devices, it has been proposed to coat certain inside and/or outside surfaces that come into contact with the fluid to be dispensed, with bactericide and/or bacteriostatic substances, e.g. layers containing silver ions. The following documents describe various prior-art solutions: EP 0 473 892, EP 0 580 460, EP 0 831 972, U.S. Pat. No. 6,227,413, EP 1 169 241, DE 2 830 977, U.S. Pat. No. 5,154,325, EP 0 644 785, U.S. Pat. No. 5,433,343, EP 0 889 757. However, those solutions are not satisfactory. Thus, the effectiveness and durability of such coatings are uncertain, and generally they do not make it possible to satisfy regulatory requirements relating to bacteriological tests for dispensers of drugs that do not contain preservatives.

An object of the present invention is to propose a surface treatment method that does not have the above-mentioned drawbacks.

In particular, an object of the present invention is to provide a surface treatment method that is effective, long-lasting, non-polluting, that does not interact with the fluid, and that is simple to perform.

The present invention thus provides a treatment method for treating the surface of a fluid dispenser device, said method comprising the step of using chemical grafting to form a thin film on at least one support surface of at least one portion of said device that is in contact with said fluid, said thin film having bactericidal and/or bacteriostatic properties.

Advantageously, said thin film is a polymeric film that includes silver ions.

Advantageously, said silver ions are in oxidized form.

Advantageously, said chemical grafting creates covalent bonds between the molecules of said thin film and said support surface. This creates a strong and long-lasting connection.

Advantageously, said chemical grafting is performed in an aqueous medium. This makes it possible to use chemistry that is non-polluting or green and that does not present any risk to the environment.

Advantageously, said chemical-grafting step is initiated by chemically activating a diazonium salt so as to form an anchor layer for said thin film.

Advantageously, said support surface is made of synthetic material, in particular comprising polyethylene and/or polypropylene.

Advantageously, said support surface is made of elastomer, glass, or metal.

Advantageously, said thin film has a thickness that is less than 1 micrometer (μm), preferably lying in the range 10 angstroms (Å) to 2000 Å. This is advantageous, since it turns out that the silver layers are more effective the thinner the layers. No conventional coating technique makes it possible to obtain layers that are as thin.

Advantageously, said dispenser device comprises: a reservoir containing the fluid; a dispenser member, such as a pump or a valve, that is fastened on said reservoir; and a dispenser head that is provided with a dispenser orifice, and this is for actuating said dispenser member.

Advantageously, said fluid is a pharmaceutical for spraying in nasal or oral manner.

More particularly, the present invention makes provision for using a method similar to the method described in document WO 2008/078052, which describes a method of preparing an organic film on the surface of a solid support under non-electrochemical conditions. Surprisingly, that type of method turns out to be suitable for forming a thin bactericidal and/or bacteriostatic film on surfaces for coming into contact with a pharmaceutical fluid in dispenser devices of the nasal or oral type. Such an application of that grafting method has not previously been envisaged.

To summarize, the method seeks to prepare a thin film, in particular a film made of polyethylene and/or polypropylene, on the surface of a solid support. The method mainly comprises putting said support surface into contact with a liquid solution. The liquid solution includes at least one solvent and at least one adhesive primer, enabling radical entities to be formed from the adhesive primer.

The “thin film” may be any bactericidal and/or bacteriostatic film, in particular of organic nature, e.g. resulting from a plurality of units of organic chemical species, and bonded in covalent manner to the surface of the support on which the method is performed. In particular, it is a film that is bonded in covalent manner to the surface of the support, and that includes at least one layer of structural units of similar nature. Depending on the thickness of the film, its cohesion is provided by covalent bonds that develop between the various units. Preferably, the thin film contains silver ions.

The solvent used in the context of the method may be of protic or aprotic nature. It is preferable for the primer to be soluble in said solvent.

The term “protic solvent” means a solvent that includes at least one hydrogen atom that is capable of being released in the form of a proton. The protic solvent may be selected from the group constituted by: water; deionized water; optionally-acidified distilled water; acetic acid; hydroxylated solvents such as methanol and ethanol; liquid glycols of small molecular weight such as ethyleneglycol; and mixtures thereof. In a first variant, the protic solvent is constituted solely by a protic solvent or by a mixture of different protic solvents. In another variant, the protic solvent or the mixture of protic solvents may be mixed with at least one aprotic solvent, it being understood that the resulting mixture should present the characteristics of a protic solvent. Acidified water is the preferred protic solvent, and more particularly, acidified distilled water or acidified deionized water.

The term “aprotic solvent” means a solvent that is considered as not being protic. Under non-extreme conditions, such solvents are not suitable for releasing a proton or for accepting one. The aprotic solvent is advantageously selected from: dimethylformamide (DMF); acetone; and dimethyl sulfoxide (DMSO).

The term “adhesive primer” corresponds to any organic molecule that is suitable, under certain conditions, for chemisorbing onto the surface of the solid support by a radical reaction, such as radical chemical grafting. Such molecules include at least a functional group that is suitable for reacting with a radical, and also a reactive function that reacts with another radical after chemiabsorption. Thus, after grafting a first molecule to the surface of the support, the molecules are capable of forming a polymeric film, and then of reacting with other molecules that are present in its environment.

The term “radical chemical grafting” refers, in particular, to the use of molecular entities that possess an unpaired electron in order to form bonds with the support surface of the covalent-bond type, said molecular entities being generated independently of the support surface onto which they are to be grafted. Thus, the radical reaction leads to covalent bonds being formed between the support surface under consideration and the derivative of the grafted adhesive primer, and then between a grafted derivative and molecules that are present in its environment.

The term “derivative of the adhesive primer” means a chemical unit resulting from the adhesive primer, after said adhesive primer has reacted by radical chemical grafting, in particular with the surface of the solid, or with another radical. To the person skilled in the art, it is clear that the function that is reactive with another radical after chemiabsorption of the derivative of the adhesive primer is different from the function involved in the covalent bonding, in particular with the surface of the solid support. Advantageously, the adhesive primer is a cleavable aryl salt selected from the group constituted by: aryl diazonium salts; aryl ammonium salts; aryl phosphonium salts; and aryl sulfonium salts.

In a variant, for the direct covalent bonds of the silver ions on the support surface as obtained in an aqueous medium, it is possible to use a method of impregnating a porous layer that has previously been grafted with silver ions.

Advantageously, the anti-bacterial surface treatment of the present invention may be combined with one or more other surface treatments so as to give one or more other properties to the treated support surface. In particular, additional thin films may be formed by chemical grafting on the same support surface so as to limit friction, limit active ingredient sticking, and/or prevent interaction between the fluid and the support surface. This may be achieved in several successive grafting steps, performed in specific mono-component baths, in any order. In a variant, it is possible to envisage performing a single chemical-grafting step in a multi-component bath.

Tests have been performed consisting in treating samples of polymeric material (polypropylene) by grafting a coating containing metal ions. Convincing results were obtained with a polyacrylic acid (PAA) based coating associated with silver ions, in particular Ag⁰ ions (reduced silver), and Ag⁺ ions (oxidized silver). The tests used S. aureus and P. aeruginosa micro-organisms. An absence or a reduction in proliferation was observed under and around the treated zones.

Various modifications may also be envisaged by a person skilled in the art, without going beyond the ambit of the present invention, as defined by the accompanying claims.

1. A treatment method for treating the surface of a fluid dispenser device, said method being characterized in that it comprises the step of using chemical grafting to form a thin film on at least one support surface of at least one portion of said device that is in contact with said fluid, said thin film having bactericidal and/or bacteriostatic properties.

2. A method according to claim 1, wherein said thin film is a polymeric film that includes silver ions.

3. A method according to claim 2, wherein said silver ions are in oxidized form.

4. A method according to claim 1, wherein said chemical grafting creates covalent bonds between the molecules of said thin film and said support surface.

5. A method according to claim 4, wherein said chemical grafting is performed in an aqueous medium.

6. A method according to claim 4, wherein said chemical-grafting step is initiated by chemically activating a diazonium salt so as to form an anchor layer for said thin film.

7. A method according to claim 1, wherein said support surface is made of synthetic material, in particular comprising polyethylene and/or polypropylene.

8. A method according to claim 1, wherein said support surface is made of elastomer, glass, or metal.

9. A method according to claim 1, wherein said thin film has a thickness that is less than 1 μm, preferably lying in the range 10 Åto 2000 Å.

10. A method according to claim 1, wherein said dispenser device comprises: a reservoir containing the fluid; a dispenser member, such as a pump or a valve, that is fastened on said reservoir; and a dispenser head that is provided with a dispenser orifice, and this is for actuating said dispenser member.

11. A method according to claim 1, wherein said fluid is a pharmaceutical for spraying in nasal or oral manner.
